(19) United States
(12) Patent Application Publication
(10) Pub. No.: US 2023/0175318 A1
(43) Pub. Date: Jun. 8, 2023

(54) PASSAGE DEVICE FOR ACCESS CONTROL AND/OR SEPARATION

(71) Applicant: dormakaba Deutschland GmbH, Ennepetal (DE)

(72) Inventors: Elmar HAUNGS, Ennepetal (DE); Ping OOI BOON, Ennepetal (DE); Patrik EIGENMANN, Ennepetal (DE)

(21) Appl. No.: 18/057,985

(22) Filed: Nov. 22, 2022

(30) Foreign Application Priority Data
Dec. 7, 2021 (EP) 21212936.5

(51) Int. Cl. E06B 11/08; E06B 3/90; E06B 3/46

(52) U.S. Cl. CPC E06B 11/08; E06B 3/90; E06B 3/4636

(57) ABSTRACT

A passage device for access control and/or separation, having at least one barrier element, which projects into a passage of the passage device and blocks the passage. The barrier element has a base body with at least one hollow space, wherein the hollow space is at least partially filled with a filling.

### CROSS-REFERENCE TO RELATED APPLICATIONS

This application is related to and claims the benefit of European Patent Application No. 21212936.5, filed on Dec. 7, 2021, the contents of which are herein incorporated by reference in their entirety.

### TECHNICAL FIELD

The disclosure relates to a passage device for access control and/or separation with at least one barrier element.

The passage device considered here is for example designed as a rotary barrier, turnstile, rotary door, revolving door or gate system. All these passage devices can be used for access control and/or separation of people or vehicles. To this end, the passage devices have at least one barrier element, which projects into the passage and thereby blocks the passage. The barrier element can thereby be a stationary barrier element or a movable barrier element, with which the passage can be optionally released. A previously known passage device, designed as a turnstile, is shown for example in EP 0 655 546 B1.

### SUMMARY

The present disclosure indicates a passage device for access control and/or separation, which has at least one barrier element for blocking the passage, which is as light as possible with simple manufacture, whilst also being robust with regard to sabotage.

The advantage is achieved by the features of the independent claim. The dependent claims have preferred further developments of the disclosure as their subject matter.

The disclosure shows a passage device for access control and/or separation. The passage device comprises at least one barrier element. This barrier element projects into a passage of the passage device and thereby blocks the passage. The passage can be a permanently blocked path, which is blocked via a stationary barrier element, for example a grille. As will be explained in detail, the passage is, however, preferably a releasable path, which can be released with a movably arranged barrier element.

The barrier element is, in contrast to the state of the art, not formed by a hollow tube filled with air, but rather has a hollow space, which is filled at least partially with a filling. To this end, the barrier element comprises a base body, in which the hollow space is designed.

The base body is preferably formed by a sleeve or a hollow profile. The base body can have basically any desired geometry and any desired cross-section. It is in particular provided that the base body as a sleeve is a closed ring-shape in the cross-section, but preferably not thereby limited to a round or oval cross-section. The sleeve completely encloses the inner hollow space with the closed, ring-shaped cross-section.

It is in particular provided that the base body extends along its length from a start to its end, wherein the base body, in particular the hollow space, can be open at the start and/or at the end.

A filling is located inside the barrier element, i.e. in the hollow space. The filling can impart increased bending stiffness to the barrier element. However, the filling is primarily provided to configure the barrier element to be more robust with regard to external intervention. The filling can in particular be designed such that the barrier element is as robust as possible with regard to mechanical intervention, in particular by means of a saw. At the same time, it is preferably noted that the filling, in particular the entire barrier element, is designed as light as possible such that the passage device can be easily assembled and the barrier element can be moved, in particular accelerated, with relatively low force.

The filling is essentially present in solid aggregate state and its material preferably differs from the material of the base body. The filling can basically be pushed into the hollow space. However, it is preferably provided that the hollow space is cast with the filling. The filling is therefore cast and hardened in the hollow space.

The base body is preferably made from metal and/or plastic. The base body can thereby be made partly of metal and partly of plastic. However, it is in particular provided that the base body is made either completely of metal or completely of plastic. The plastic is preferably a fiber-reinforced plastic.

It is in particular provided that the hollow space of the base body is filled completely or almost completely with the filling. In a preferred design, it is provided that at least 50%, in particular at least 80%, of the hollow space is filled with the filling. The percentage information thereby refers to the volume.

The filling is preferably formed of plastic or metal or a concrete mixture. The filling is preferably castable as a result. The plastic is preferably a synthetic resin. The metal is preferably a castable metal, in particular an aluminum alloy or steel or stainless steel, in particular a steel alloy or a stainless steel alloy. Aluminum can thereby reduce the weight. Steel can thereby deliver advantages of stability. The filling can thereby have an additive or a plurality of different additives.

Stone or a mineral is preferably used as the only or one of a plurality of additives. The mineral is in particular corundum. A stone or mineral is particularly preferably used as the additive, which has a Mohs' hardness of at least 5, further preferably at least 8, particularly preferably at least 10.

Additionally or alternatively, rubber and/or fibers can be used as the additive. In the case of the fibers, plastic fibers are in particular used.

The indicated additives enable in particular a relatively high resistance of the filling with respect to an external intervention by means of a saw.

The barrier element is preferably dimensioned as follows: The barrier element has an outer diameter of preferably at least 20 mm, in particular at least 30 mm, in particular at least 50 mm and/or the barrier element preferably has an outer diameter of at most 300 mm, in particular at most 200 mm, in particular at most 150 mm; and/or the base body preferably has a wall thickness of at least 0.5 mm, in particular at least 1 mm, in particular at least 2 mm, in particular at least 3 mm; and/or the base body preferably has a wall thickness of up to 10 mm, in particular up to 5 mm, in particular up to 3 mm. The larger wall thicknesses thereby ensure greater security and the smaller wall thicknesses help to reduce the weight. The outer diameter is in particular measured in its center in relation to the longitudinal extension of the barrier element. The wall thickness is also preferably measured in its center in relation to the longitudinal extension of the barrier element.

Moreover, it is preferably provided that the barrier element extends over a first length. The base body thereby extends over a second length. The filling thereby extends over a third length. The three lengths are measured parallel, in particular coaxially to one another. The barrier element can essentially have other elements, such as for example an end cap or a connection element in addition to the base body. The barrier element can for example be fastened to a rotary column or similar via the connection element. Therefore, the base body can be shorter than the barrier element. It is also preferably provided that the second length extends over at least 50%, preferably at least 80%, of the first length. The base body is preferably completely filled with the filling. However, partial regions of the base body may also not be filled. It is preferably provided that the third length extends over at least 50%, preferably at least 80%, particularly preferably at least 90%, of the second length.

The at least one barrier element for blocking and releasing the passage is preferably arranged so as to be movable, in particular rotationally-movable or displaceable, relative to a support element of the passage device. This support element is a stationary part of the passage device, on which stationary barrier elements can also be arranged, for example in the form of a barrier screen of a turnstile.

In particular, the passage device can have a preferably electromechanical drive in order to move the barrier element. Therefore, the passage can be optionally blocked or released, preferably without a user having to manually actuate the barrier element. As a result, the passage device can be designed as an automatic passage device.

It is preferably provided that the passage device comprises a plurality of, in particular at least three or at least four, barrier elements, which preferably project parallel to one another, in particular in a vertical or horizontal or diagonal alignment, into the passage and preferably block the passage. Through this arrangement of a plurality of barrier elements arranged in parallel, a greater region in relation to the width or the height of the passage can be blocked.

It is preferably provided that the described passage device is designed as a rotary barrier. The rotary barrier comprises at least two of the barrier elements in the form of barrier arms. These barrier arms are mounted so as to be rotatable about a common axis of rotation.

The passage device is preferably designed as a turnstile, in particular having at least one rotary arm and/or having at least one turnstile wing, in particular a plurality of turnstile wings and/or having at least one barrier screen and/or having at least one turnstile column. The rotary arm of the turnstile and/or the turnstile wing of the turnstile and/or the barrier screen of the turnstile and/or the turnstile column of the turnstile preferably have at least one of the barrier elements or is/are designed as such a barrier element. The turnstile can therefore have at least one turnstile wing, which is preferably mounted so as to be rotatable on the turnstile column. Moreover, the turnstile can preferably have a barrier screen. The described barrier elements can be used both on the barrier screen and on the turnstile wings. In this case, it concerns movable barrier elements in the region of the turnstile wing. In the case of the barrier screen, stationary barrier elements are used.

Moreover, the described passage device can be designed as a rotary door with at least one rotary door leaf. At least one of the described barrier elements is thereby located on the rotary door leaf.

Moreover, the described passage device can be designed as a revolving door with at least one revolving door leaf, wherein at least one of the revolving door leaves has at least one of the barrier elements. The barrier element can thereby be designed as a frame element of the revolving door leaf.

Moreover, the described passage device can be designed as a sliding door system having at least one sliding door leaf, wherein at least one of the sliding door leaves has at least one of the barrier elements. The barrier element can thereby be designed as a frame element of the sliding door leaf, in particular as a frame element of a curved sliding door.

Moreover, it is provided that the described passage device is designed as a gate system having a gate. The gate system has in particular a gate which is designed as a rotary gate or sliding gate. This gate has at least one of the described barrier elements.

### BRIEF DESCRIPTION OF THE DRAWINGS

The disclosure will now be explained further on the basis of an exemplary embodiment, in which is shown:

FIG. 1 a perspective view of a barrier element of a passage device according to the disclosure in accordance with the exemplary embodiments,

FIG. 2 the section A:A marked in FIG. 1,

FIG. 3 the section B:B marked in FIG. 1,

FIG. 4 a passage device according to the disclosure in accordance with a first exemplary embodiment, and

FIG. 5 a passage device according to the disclosure in accordance with a second exemplary embodiment.

### DETAILED DESCRIPTION OF THE DRAWINGS

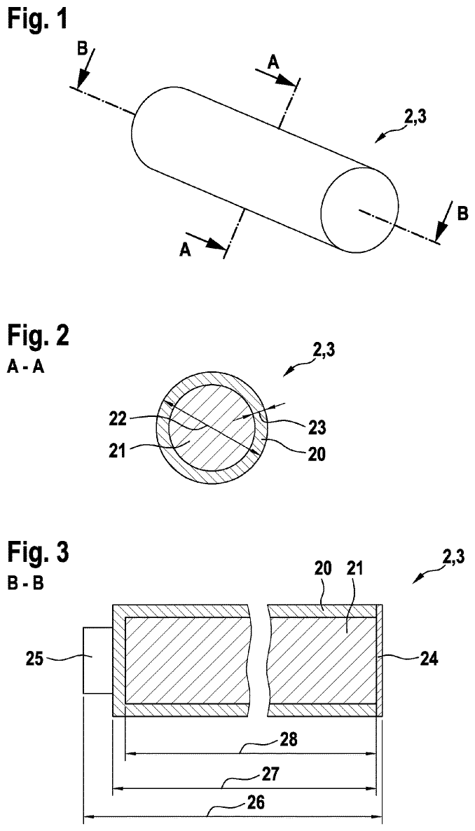

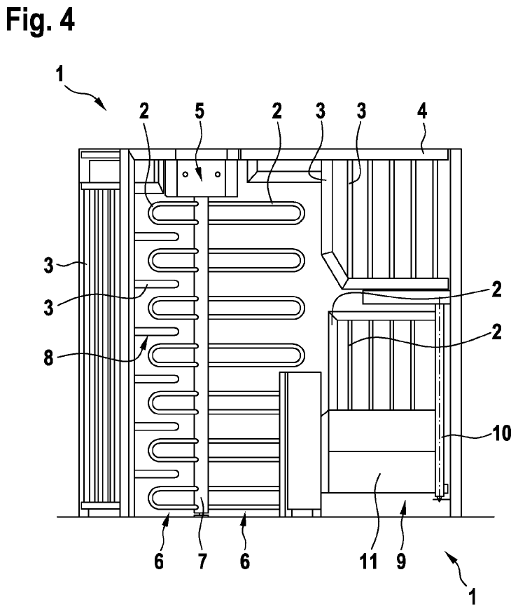

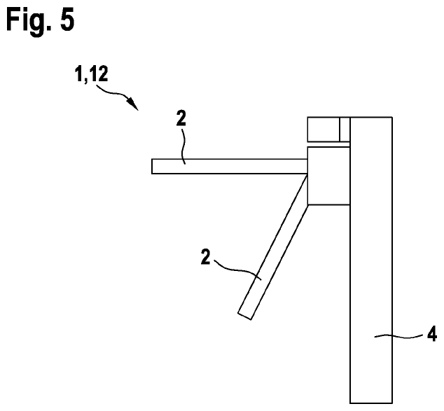

A barrier element 2, 3 of a passage device 1 will be described in detail below on the basis of FIGS. 1 to 3. The barrier element 2, 3 according to FIGS. 1 to 3 can be used in any passage device 1; thus even in the passage devices according to the first exemplary embodiment from FIG. 4 and the second exemplary embodiment from FIG. 5.

FIG. 1 shows in a purely schematic view a perspective view of a barrier element 2, 3 which can be used both as a movable barrier element 2 and as a stationary barrier element 3. The sections in FIGS. 2 and 3 show the exact structure of the barrier element 2, 3.

The barrier element 2, 3 has a base body 20 designed as a sleeve. The base body 20 is, as explained in the general part of the description, preferably made of metal or plastic.

A filling 21 is located inside the base body 20, i.e. in the hollow space of the base body 20. In the exemplary embodiment shown, the base body 20 is completely, i.e. over the entire diameter and the entire length, filled with the filling 21. The filling 21 is, as explained in the general part of the description, formed of metal or plastic, if applicable with the described additives.

The base body 20 has a wall thickness 23 and an outer diameter 22. The outer diameter 22 and the wall thickness 23 are dimensioned in particular as has been explained in the general part of the description.

FIG. 3 shows purely schematically that the barrier element 2, 3 can extend from a connection element 25 to an end cap 24. Due to the connection element 25 or another configuration of this region of the barrier element 2, 3 and, if applicable due to an end cap 24 or another closure of the hollow space, the entire barrier element 2, 3 can be configured with a first length 26 to be longer than the base body 20 with its second length 27. The filling 21 extends over a third length 28 inside the base body 20. The dimensioning of the three lengths 26, 27, 28 has been explained in the general part of the description.

FIG. 4 shows the configuration of the passage device 1 as a turnstile 5 and as a revolving door 9. The turnstile 5 has a turnstile column 7, which is aligned vertically and is rotatable. Two or three turnstile wings 6 extend from this turnstile column 7.

Each turnstile wing 6 has a plurality of movable barrier elements 2 which extend in a horizontal direction from the turnstile column 7. By rotating the turnstile wings 6, access control and/or separation of people entering takes place.

Moreover, FIG. 4 shows that the turnstile 5 can have a barrier screen 8. This barrier screen 8 is formed by a plurality of horizontal stationary barrier elements 3. The stationary barrier elements 3 of the barrier screen 8 are spaced apart from one another in such manner that the movable barrier elements 2 of the turnstile wings 6 can be moved in between them.

Furthermore, FIG. 4 shows how the passage device 1 can be designed as a rotary door 9. In the exemplary embodiment shown according to FIG. 4, this rotary door 9 is located on the right side and serves for example for passing through the passage with bicycles, strollers or other objects. The rotary door 9 has a rotary door column 10 on which the rotary door wing 11 is fastened. The rotary door leaf 11 is formed at least partially by movable barrier elements 2. These barrier elements 2 are designated here as movable barrier elements 2 since they are part of the rotary door leaf 11 and are moved to release the passage.

Moreover, the exemplary embodiment shows in FIG. 4 in the upper right region a stationary grille which is formed by stationary barrier elements 3. Left of the turnstile 5 are vertically aligned grille rods which are also formed by stationary barrier elements 3.

The frame of the passage device 1 in FIG. 4 can be designated generally as support element 4. The movable barrier elements 2 are moved directly or indirectly relative to this support element 4 in order to optionally block and release the passage. The stationary barrier elements 3 are stationary in relation to the support element 4 and permanently block the passage in the region in which they are arranged.

FIG. 5 shows the configuration of the passage device 1 as a rotary barrier 12. In the case of the rotary barrier 12, two movable barrier elements 2 are designed as so-called “barrier arms”. These movable barrier elements 2 designed as barrier arms are rotatable about a common axis relative to the illustrated support element 4 in order to thus control access and to achieve separation at the same time.

1. A passage device for access control and/or separation, the passage device comprising: at least one barrier element, which projects into a passage of the passage device and blocks the passage, wherein the barrier element has a base body with at least one hollow space, wherein the hollow space is at least partially filled with a filling.

2. The passage device according to claim 1, wherein the hollow space is cast with the filling.

3. The passage device according to claim 1, wherein the base body is made of metal and/or plastic.

4. The passage device according to claim 1, wherein the filling fills the hollow space up to at least 50%.

5. The passage device according to claim 1, wherein the filling is formed at least partially of plastic, or metal, a concrete mixture with or without additive.

6. The passage device according to claim 5, wherein a stone or mineral is added as the additive, wherein the stone or mineral preferably has a Mohs' hardness of at least 5.

7. The passage device according to claim 5, wherein rubber and/or fibers are added as the additive.

8. The passage device according to claim 1,
wherein the barrier element has an outer diameter of at least 20 mm,
and/or wherein the barrier element has an outer diameter of at most 300 mm,
and/or wherein the base body has a wall thickness of at least 0.5 mm, in particular at least 1 mm,
and/or wherein the base body has a wall thickness of up to 10 mm.

9. The passage device according to claim 1, wherein the at least one barrier element for blocking and releasing the passage is arranged so as to be movable, or displaceable, relative to a support element of the passage device.

10. The passage device according to claim 1, wherein the base body is designed as a sleeve or as a hollow profile.

11. The passage device according to claim 1, designed as a rotary barrier, wherein at least two of the barrier elements in the form of barrier arms are mounted so as to be rotatable about a common axis.

12. The passage device according to claim 1, designed as a turnstile, having at least one rotary arm and/or having at least one turnstile wing, and/or having at least one barrier screen and/or having at least one turnstile column, wherein the rotary arm of the turnstile and/or the turnstile wing of the turnstile and/or the barrier screen of the turnstile and/or the turnstile column of the turnstile has at least one of the barrier elements or is/are designed as the barrier element.

13. The passage device according to claim 1, designed as a rotary door having at least one rotary door leaf, wherein the at least one rotary door leaf has at least one of the barrier elements.

14. The passage device according to claim 1, designed as a revolving door having at least one revolving door leaf, wherein the revolving door leaf has at least one of the barrier elements.

15. The passage device according to claim 1, designed as a sliding-door system having at least one sliding door leaf, wherein the sliding door leaf has at least one of the barrier elements.
